(19) United States
(12) Patent Application Publication
(10) Pub. No.: US 2025/0129662 A1
(43) Pub. Date: Apr. 24, 2025

(54) DUAL-SHUTTER TELESCOPIC DOOR RAILING

(71) Applicant: GUANGZHOU TUSUNNY HOME PRODUCTS CO., LTD, Guangzhou (CN)

(72) Inventor: HONGJUAN WANG, Guangzhou (CN)

(21) Appl. No.: 18/772,531

(22) Filed: Jul. 15, 2024

(30) Foreign Application Priority Data
Oct. 19, 2023 (CN) 202322814606.6

(51) Int. Cl. E06B 9/13; E06B 9/00

(52) U.S. Cl. CPC E06B 9/13; E06B 2009/002

(57) ABSTRACT

The present invention discloses a dual-shutter telescopic door railing and, in the technical solution of the invention, two reels are pivotally provided between the upper fixed seat and the lower fixed seat to connect with the rolling shutter component, a torsion spring that can automatically retract the rolling shutter component is disposed inside the reel and, after assembly, the invention forms a dual-shutter structure having two rolling shutter components, improving the range of application and the applicability of telescopic door railings.

### CROSS-REFERENCE TO RELATED APPLICATIONS

This application claims priority to Chinese Patent Application No. 202322814606.6, filed on Oct. 19, 2023, which is hereby incorporated by reference in its entirety.

### TECHNICAL FIELD

The present invention relates to the technical field of telescopic door railings, in particular to a dual-shutter telescopic door railing.

### BACKGROUND

In families with infants, in order to protect infants walking out of the room against accidents such as getting lost or personal injury, people often install a telescopic door railing in positions like doors, stairwells or corridors and the like.

The Chinese patent application number CN202320165782.9, for example, discloses an adjustable telescopic protective door railing, mainly including an upper fixed seat, a lower fixed seat, a rolling shutter component, reel and the like, and the reel can be pivotally installed between the upper fixed seat and the lower fixed seat, and the rolling shutter component's shutter body is installed on the reel and can be pulled out for use and, when not in use, can be retracted in place by driving the reel to rotate under the elastic torsion action of the spring.

Existing telescopic door railings are designed with a single-shutter structure, but the shutter faces a limited length of portion that can be pulled out, which is not suitable for use in spacious areas. The single-shutter structure's load-bearing capacity is too insufficient to withstand large impact forces, resulting in the destruction of the shutter and even other components of the telescopic door railing when they are dragged by the shutter.

### SUMMARY

The main purpose of the present invention is to propose a dual-shutter telescopic door railing to address the problems proposed in the background art mentioned above.

To achieve the above purpose, the present invention proposes a dual-shutter telescopic door railing, including an upper fixed seat, a lower fixed seat, two pivotable reels that can be installed between the upper fixed seat and the lower fixed seat, and a roller shutter component located on the reel, and the reel is internally provided with a torsion spring to apply elastic force to the reel, so that the reel can rotate in a direction that makes the roller shutter component retract.

The present invention discloses a dual-shutter telescopic door railing and, in the technical solution of the invention, two reels are pivotally provided between the upper fixed seat and the lower fixed seat to connect with the rolling shutter component, a torsion spring that can automatically retract the rolling shutter component is disposed inside the reel and, after assembly, the invention forms a dual-shutter structure having two rolling shutter components; compared with traditional structures, the two shutter bodies of the dual-shutter structure can be pulled out in the same direction and fixed to form a two-layer barrier, effectively improving the impact resistance ability, and the two shutter bodies can also be pulled out in different directions, for example, in opposite directions, and then fixed to form a barrier that is equivalent to twice the range of a single-shutter structure, suitable for use in relatively spacious areas, improving the range of application and the applicability of telescopic door railings.

### BRIEF DESCRIPTION OF DRAWINGS

FIG. 1 is a 3D view of the present invention;

FIG. 2 is an assembly diagram of the connecting rod, upper connecting seat, lower connecting seat, and pillar;

FIG. 3 is a schematic diagram of the upper and lower connecting seats;

FIG. 4 is a cross-sectional view of the upper connecting seat;

FIG. 5 is an assembly diagram of the second ratchet wheel, second pawl, and sixth top spring;

FIG. 6 is a 3D view of the upper fixed seat;

FIG. 7 is an exploded view of the upper fixed seat;

FIG. 8 is an assembly diagram of the first ratchet wheel, first pawl, swinging member, and lower seat;

FIG. 9 is a schematic diagram of the unlocking member, seat, and support.

### DETAILED DESCRIPTION OF THE EMBODIMENTS

The technical solutions in the embodiments of the present invention will be described clearly and completely in conjunction with the accompanying drawings of the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

It should be noted that all directional indicators (such as up, down, left, right, front, back, top, bottom, inside, outside, vertical, horizontal, vertical, counterclockwise, clockwise, circumferential, radial, axial . . . ) in the embodiments of the present invention are only used to explain the relative position relationship and movement among various components in a particular posture (as shown in the accompanying drawings), and if that particular posture is changed, the directional indications will change accordingly.

In addition, descriptions involving terms “first,” “second” and the like, if any, in the present invention are only for illustrative purposes and cannot be understood as indicating or implying relative importance or the number of features referred to. Therefore, the features defined with “first” and “second” may explicitly or implicitly include at least one or a plurality of the features. At the same time, the technical solutions of various embodiments can be combined with each other, but must be based on what those of ordinary skill in the art can achieve. The combination of technical solutions that result in contradiction or make it impossible to implement should be considered non-existent, and accordingly should not fall within the scope of protection required by this present invention.

The present invention proposes a dual-shutter telescopic door railing.

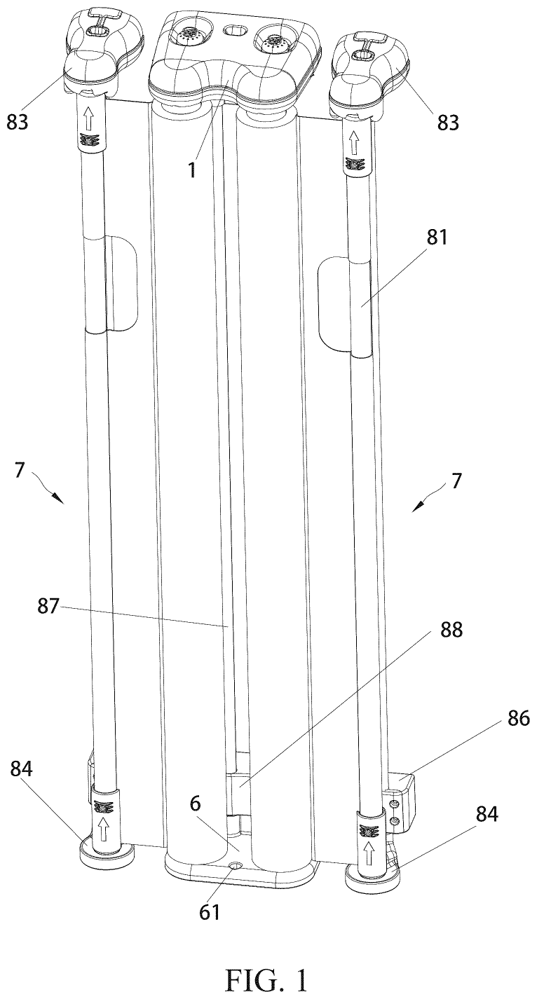

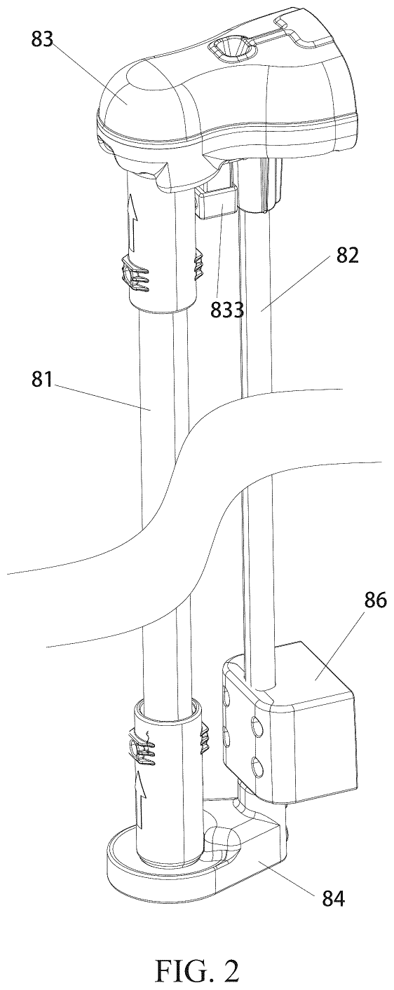

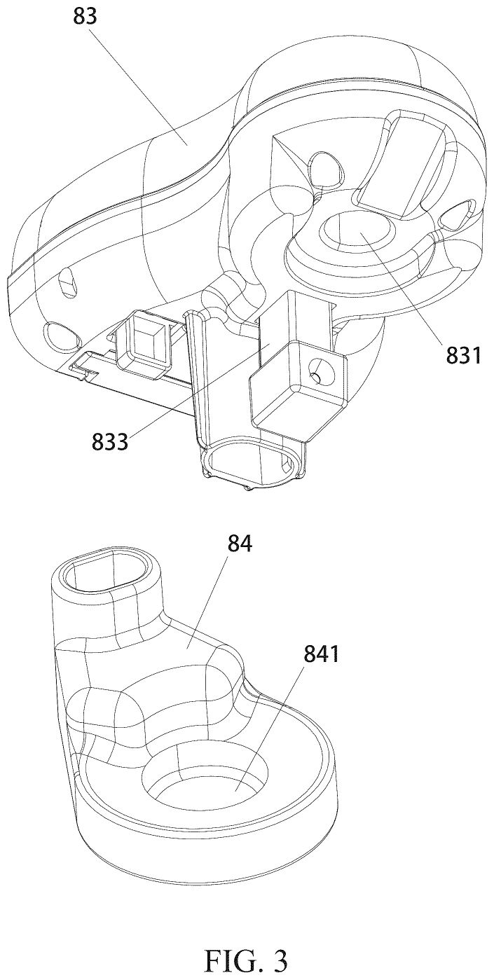

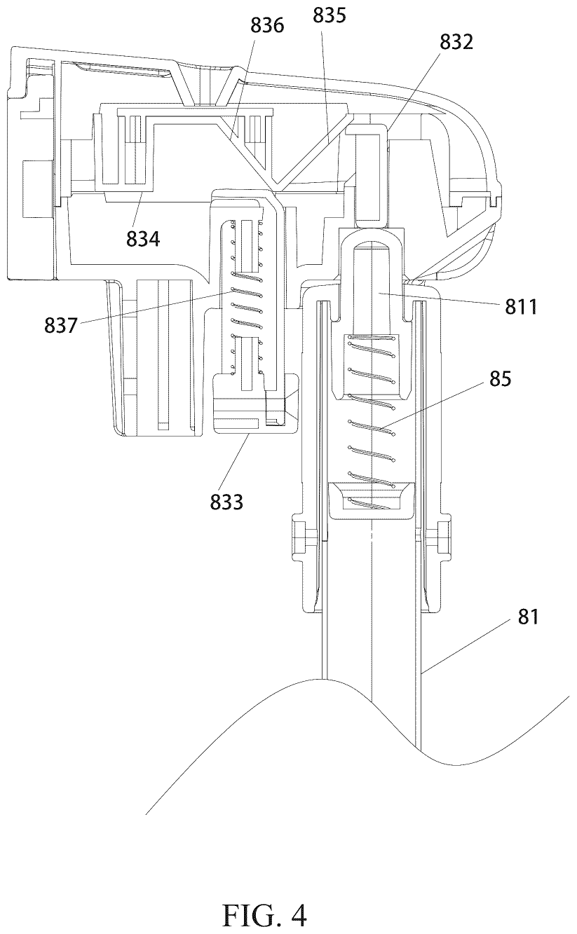

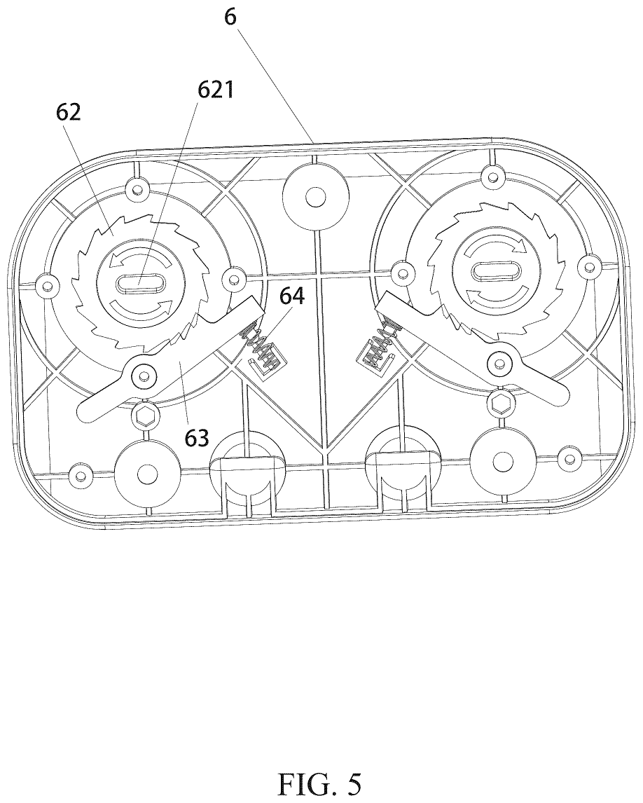

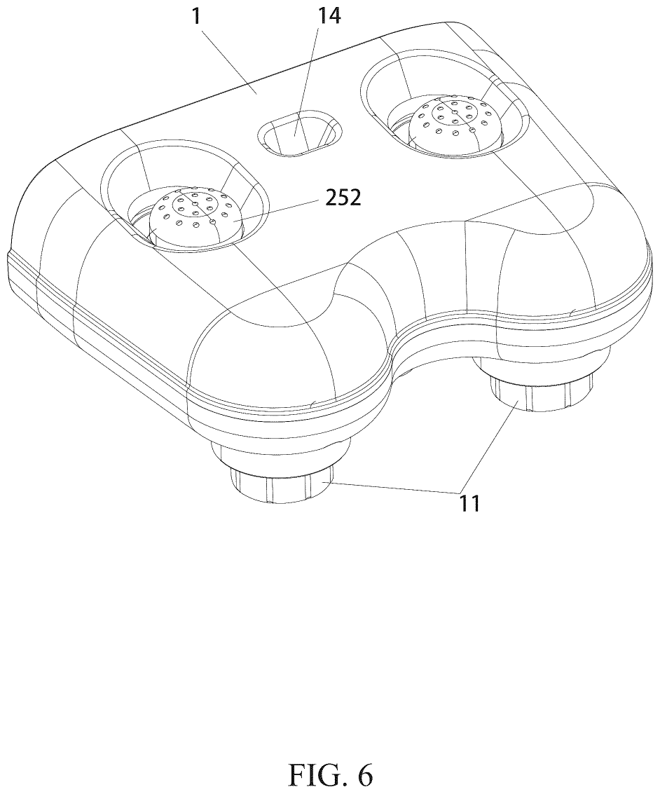

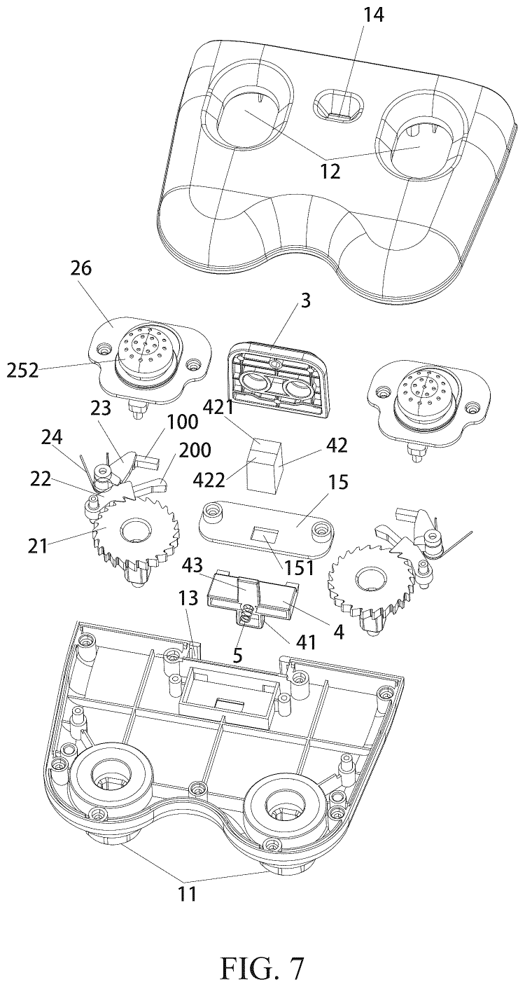

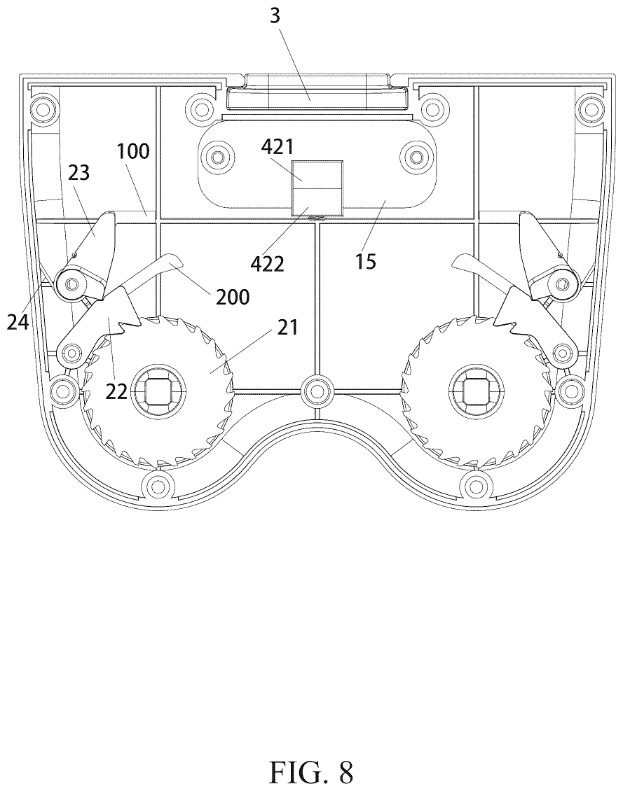

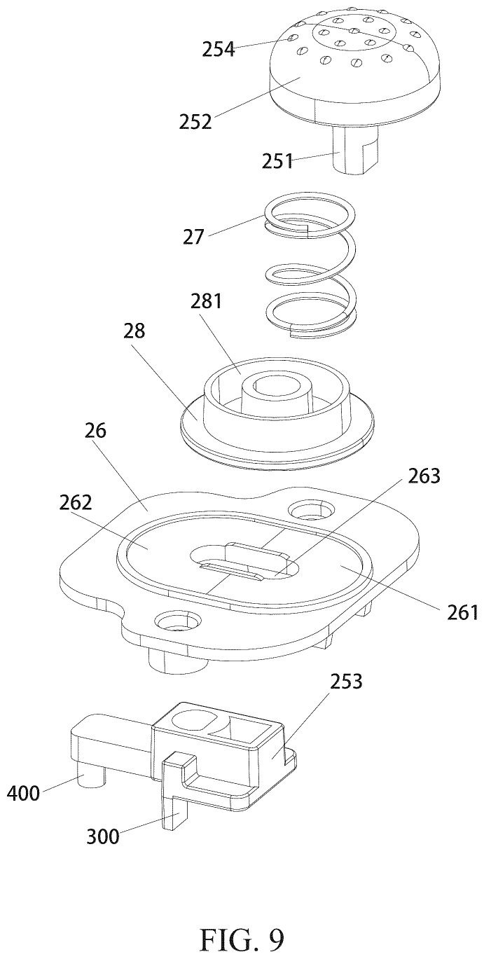

In the embodiments of the invention, as shown in FIGS. 1 to 9, the dual-shutter telescopic door railing, including an upper fixed seat (1), a lower fixed seat (6), two reels that can be pivotally installed between the upper fixed seat and the lower fixed seat (6), and a rolling shutter component (7) located on the reel, the reel is internally provided with a torsion spring to apply elastic force to the reel, so that the reel can rotate in a direction that makes the roller shutter component (7) retract.

The present invention discloses a dual-shutter telescopic door railing and, in the technical solution of the invention, two reels are pivotally provided between the upper fixed seat and the lower fixed seat to connect with the rolling shutter component, a torsion spring that can automatically retract the rolling shutter component is disposed inside the reel and, after assembly, the invention forms a dual-shutter structure having two rolling shutter components; compared with traditional structures, the two shutter bodies of the dual-shutter structure can be pulled out in the same direction and fixed to form a two-layer barrier, effectively improving the impact resistance ability, and the two shutter bodies can also be pulled out in different directions, for example, in opposite directions, and then fixed to form a barrier that is equivalent to twice the range of a single-shutter structure, suitable for use in relatively spacious areas, improving the range of application and the applicability of telescopic door railings.

Specifically, the two reels are opposite in the rotation direction, for example, when one of the reels rotates forward to wind shutter component 7, while the other reel rotates in reverse to wind shutter component 7.

Specifically, the bottom of the upper fixed seat is pivotally spaced with two connecting ends 11 for connection with the reel, and a locking mechanism is provided to lock the connecting end 11 with the upper fixed seat 1, therefore locking the reel.

Specifically, the locking mechanism locks both connecting ends simultaneously, or the number of locking mechanisms is two, the two locking mechanisms lock the two connecting ends separately, and the two locking mechanisms have the same or different structures; in this embodiment, two locking mechanisms are provided to facilitate the separate locking or unlocking of the reels, and reference can be made to the prior art for the specific structures of the two locking mechanisms, for example, knob type locking mechanisms, press type locking mechanisms, or the following embodiments can be adopted: the connecting end 11 can be pivotally installed at the bottom of the upper fixed seat 1, the locking mechanism includes a first ratchet wheel 21 located inside the upper fixed seat 1 for fixed connection with the top of the connecting end 11, and a first pawl 22 can be pivotally provided inside the upper fixed seat 1 on the side corresponding to the first ratchet wheel 21, the first pawl 22 can swing between the position where it is engaged with the first ratchet wheel 21 and the position where it is far away from the first ratchet wheel 21, and a swinging member 23 can be pivotally installed on the side of the first pawl 22, far away from the first ratchet wheel 21, inside the upper fixed seat 1, and the swinging member 23 can swing between the position where it is partially engaged with the outer side of the first pawl 22 and the position where it is far away from the first pawl 22, and the locking mechanism also includes a first top spring 24 and an unlocking member, the first top spring 24 is used to apply elastic force to the direction in which swinging member 23 engages with the first pawl 22, the unlocking member is linked to the first pawl and the swinging member, and the unlocking member is partially exposed outside the upper fixed seat, the exposed part can be used to control the movement of unlocking member to force the swinging member 23 to swing away from the first pawl 22 and to force the first pawl 22 to swing away from the first ratchet wheel 21. When the first pawl 22 engages with the first ratchet wheel 21 and the swinging member 23 is locked with the first pawl 22, the connecting end 11 and the upper fixed seat 1 are locked. After the swinging member 23 moves away from the first pawl 22 and the first pawl 22 moves away from the first ratchet wheel 21, the connecting end 11 is unlocked.

Specifically, the unlocking member is movably assembled on the upper fixed seat 1, with its lower part located inside the upper fixed seat 1 and the top exposed to the surface of the upper fixed seat 1, the swinging member 23 is provided with a first forced moving portion 100, and the first pawl 22 is provided with a second forced moving portion 200, the lower part of the unlocking member is respectively provided with a first pushing portion 300 for contact with the first forced moving portion 100 and a second pushing portion 400 for contact with the second forced moving portion 200, the unlocking member can perform horizontal linear reciprocating motion relative to the upper fixed seat 1, and the first pushing portion 300 can, along with the movement of the unlocking member, move between the position where it forces the first forced moving portion 100 to drive the swinging member 23 to swing away from the first pawl 22 and the position where it is away from the first forced moving portion 100, and the second pushing portion 400 can, along with the movement of the unlocking member, move between the position where it forces the second forced moving portion 200 to drive the first ratchet wheel 22 to swing away from the first pawl 22 and the position where it is away from the second forced moving portion 200.

Specifically, in the embodiment where the locking mechanism simultaneously locks two connecting ends 11, one locking mechanisms is provided, and therefore, two first pushing portions 300 and two second pushing portions 400 are respectively provided at the lower end of the unlocking member so that the two connecting ends 11 can be synchronously unlocked.

Of course, in other embodiments, the two connecting ends 11 can also be locked by two different locking mechanisms of different structures.

A position on the top of the upper fixed seat 1 corresponding to the unlocking member is provided with a through-hole 12 in which the the unlocking member can perform linear reciprocating motion, a support 26 is fixed below the through-hole 12 inside the upper fixed seat 1, and the support 26 is provided with a color plate formed together by the first locking mark 261 and the first unlocking mark 262, the color plate is aligned up and down with the through-hole 12, and the top of the unlocking member can move along the through-hole 12 between the position where the first locking mark 261 is covered and the position where the first unlocking mark 262 is covered. The first locking mark 261, when being covered, can be observed through the through hole 12, so that the user can know that the unlocking member has moved to the position where the connection end 11 is unlocked and, when the unlocking member moves to the position where the connection end 11 is locked, the top of the unlocking member covers the first unlocking mark 262, and the first locking mark 261 can be observed through the through hole 12.

The unlocking member is a support rod 251 that can vertically move through the support 26, the upper and lower parts of the support rod 251 are respectively provided with a cap portion 252, and a connecting block 253 having the first pushing portion 300 and the second pushing portion 400, the support rod 251 can perform vertical reciprocating motion relative to the support member 26, the first pushing portion 300 can, along with the movement of support rod 251, move between the position where it is staggered from the first forced moving portion 100 and the position where it is horizontally opposite the first forced moving portion 100, and the second pushing portion 400 can move between the position where it is staggered from the second forced moving portion 200 and the position where it is horizontally opposite the second forced moving portion 200, and a second top spring 27 is provided to apply the elastic force to the unlocking member that causes the first pushing portion 300 and the second pushing portion 400 to move in opposite directions to the first forced moving portion 100 and the second forced moving portion 200, respectively. When the first pushing portion 300 is staggered from the first forced moving part 100, the unlocking member performing horizontal linear reciprocating motion cannot cause the first pushing portion 300 to push the first forced moving part 100, nor unlock the connecting end 11. To unlock the connecting end 11, first press the unlocking member to make the first pushing portion 300 and the second pushing portion 400 simultaneously descend to the positions horizontally opposite to the first forced moving portion 100 and the second forced moving portion 200, and then push the unlocking member to perform horizontal linear motion.

Specifically, the support member 26 is provided with a strip hole 263 for the support rod 251 to move through.

A seat 28 is provided at a corresponding position on the support rod 251 above the support member 26, and the top wall of support 26 is concave to form an activity space for the seat 28 to move, the color plate is located at the bottom of activity space, and a convex ring 281 that can be inserted into the inner side of cap body is provided at a position on the seat 28 corresponding to the inner side of cap body extending towards the direction of cap body, the second top spring 27 is sleeved on the support rod 251, and one end of the second top spring 27 is in contact with the seat 28, and the other end is elastically in contact with the inner top wall of the cap portion 252.

The top wall of the cap portion 252 is provided with a plurality of non-slipping blocks 254.

Specifically, reference can be made to prior art or the following embodiments for how to mount the upper fixed seat 1 specifically in the installation position: the upper fixed seat 1 is detachably fixed to the installation position through a quick release structure.

Specifically, the quick release structure includes a plug board 3 that is locked by bolts or detachably fixed at installation position through a buckle structure, a slot 13 is provided on the side of upper fixed seat 1 facing the installation position for the bottom-top insertion of plug board 3, the inner side of the upper fixed seat 1 is movably provided with an unlock key 4 that can move, relative to the upper fixed seat 1, between the position where it is partially connected to the plug board 3 and the position away from the plug board 3, the unlock key 4 can lock the plug board 3 and the slot 13 when the plug board 3 is partially plugged; a third top spring 5 is additionally provided to apply elastic force to the unlock key 4 to move in the direction in which the unlock key 4 is partially plugged with the plug board 3.

Specifically, the unlock key 4 is provided with a driving end 41 that extends out of the upper fixed seat 1, the driving end 41 can be manually controlled to drive the unlock key 4 to move away from the insertion direction to unlock the plug board 3 and the slot 13, the top of unlock key 4 is connected to the block 42, and the top wall of the block 42 is provided with a second locking mark 421 and a second unlocking mark 422 which are adjacent to each other, an observation window 14 is provided at the position on the top of the upper fixed seat 1 corresponding to the block 42, and when the unlock key 4 moves to the position where it is partially plugged in the plug board 3, the second locking mark 421 is aligned up and down with the observation window 14; when the unlock key 4 moves to the position where it is away from the plug board 3, the second unlocking mark 422 is aligned up and down with the observation window 14.

Specifically, a connecting plate 15 having an avoidance hole 151 is fixed at a position below the corresponding block 42 inside the upper fixed seat 1, the unlock key 4 is located below the connecting plate 15, and a connecting portion 43 that can pass through the avoidance hole 151 is provided on the top of unlock key 4, and the connecting portion 43 is connected to the block 42 after passing through the avoidance hole 151.

Specifically, the upper fixed seat 1 is formed by the upper cover and lower seat that are assembled together and locked with screws, or fixed with a buckle structure.

Specifically, the dual-shutter telescopic door railing further includes a connecting mechanism for detachably connecting the shutter body of the rolling shutter component 7, after unfolding, to the free end of the shutter body.

Specifically, reference can be made to prior art, such as hooks, or to the following embodiments for the connecting mechanism: the connecting mechanism includes a connecting rod 81, a pillar 82, an upper connecting seat 83, and a lower connecting seat 84, the upper connecting seat 83 and the lower connecting seat 84 are respectively connected to the two ends of the pillar 82, and the connecting rod 81 is connected to the free end of the shutter body, and the shutter body, after being pulled out, can be detachably connected to the upper connecting seat 83 and the lower connecting seat 84 through the two ends of the connecting rod 81 so that the free end of the shutter body and the connecting mechanism are detachably connected.

Specifically, the bottom of the lower connecting seat 84 is provided with a first slot 841 for the insertion of the lower end of connecting rod 81, the upper connecting seat 83 is provided with a second slot 831, the upper end of the connecting rod 81 is movably provided with a locking member 811, and the locking member 811 can move relative to the connecting rod between the position where the locking member 811 extends into the second slot 831 to lock the connecting rod 81 and the position where the locking member 811 exits from the second slot 831 to unlock the connecting rod 81, and the connecting rod 81 is internally provided with a fourth top spring 85 that is used to apply elastic force to the locking element 811 in the direction in which the locking element 811 extends into the second slot 831.

Specifically, a first moving member 832 and a second moving member 833 are vertically and movably installed inside the upper connecting seat 83, and the first moving member 832, during descending, can force the locking member 811 to exit the second slot 831, the second moving member 833 that partially extends out of the upper connecting seat 83 is exposed to the outside, the upper connecting seat 83 is also movably installed with a third moving member 834, and the bottom of the third moving member 834 is provided with a first inclined plane 835 and a second inclined plane 836 that are in opposite directions, the third moving member 834 can move between the position where the third moving member 834, through the first inclined plane 835, forces the first moving member 832 to perform a downward motion and the position where the third moving member 834, through the second inclined plane 835, forces the second moving member 833 to perform a downward motion, and a fifth top spring 837 is additionally provided to apply elastic force to the second moving member 833 in the direction in which the second moving member 833 moves away from the second inclined plane 836. Specifically, the partially exposed portion of the second moving member 833 can be pressed to force the second moving member 833 to move upwards, thereby driving the third moving block, through the second inclined plane 836, towards the direction close to the first moving block, until the first inclined plane 835 forces the first moving block to move downwards and the locking member 811 to exit the second slot 831, unlocking the upper end of the connecting rod 81.

Specifically, the pillar 82 is movably sleeved with a first slider 86 for fixed connection with the installation position. The first slider can perform vertical reciprocating motion along the pillar and, when an installation position has a skirting line, the first slider 86 can be slid to avoid the skirting line and then connected to the installation position.

Specifically, reference can be made to the prior art for the specific installation of the upper connecting seat 83 and the first slider 86 in the installation position, or the quick release structure used by the upper fixed seat can be adopted.

Specifically, reference can be made to prior art for the rolling shutter component 7, and its specific structural principle will not be elaborated here.

Specifically, the upper fixed seat and the lower fixed seat 6 are fixedly connected by a support rod 87, and the lower fixed seat 6 is provided with a vertical penetrating installation hole 61 that is used to, together with bolts, lock the lower fixed seat 6 on the ground.

Specifically, the lower fixed seat 6 can be pivotally mounted with a second ratchet wheel 62 for connecting with the end of the torsion spring, and the second ratchet wheel 62 can rotate, relative to the lower fixed seat 6, in the direction of radial contraction of the torsion spring to adjust the torsion force of torsion spring.

Specifically, a second pawl 63 can be pivotally installed at a position on one side of the lower fixed seat 6 corresponding to the second ratchet wheel 62, the second pawl 63 can move between the position where it engages with the second ratchet wheel 62 and the position where it disengages with the second ratchet wheel 62, and the ratchet wheel, when engaged, can only rotate in the direction that causes the torsion spring to contract radially, a sixth top spring 64 is additionally provided to apply elastic force to the second pawl 63 so that the second pawl 63 swings in the direction of engagement with the second ratchet wheel 62 and maintains contact with the second ratchet wheel 62.

Specifically, the lower fixed seat 6 is open at the position corresponding to the center of the second ratchet wheel 62, and a strip groove 621 is provided at the center of the second ratchet wheel 62. A tool can be inserted into the strip groove 621 to rotate the second ratchet wheel 62, so as to manually adjust the torque of the torsion spring.

Specifically, the pillar 82 is movably sleeved with a second slider 88 for fixed connection with the installation position, the second slider 88 can perform vertical reciprocating motion along the support rod and, when an installation position has a skirting line, the second slider 88 can be slid to avoid the skirting line and then connected to the installation position. Reference can be made to the prior art for the specific installation of the second slider 88 in the installation position, or the quick release structure used by the upper fixed seat can be adopted.

The above are only the preferred embodiments of the present invention, and are not intended to limit the present invention. Any equivalent structural transformation made based on the description and accompanying drawings hereof under the concept of present invention, or be directly/indirectly applied in other related technical fields, should fall within scope of patent protection of the present invention.

What is claimed is:

1. A dual-shutter telescopic door railing, including an upper fixed seat (1), a lower fixed seat (6), two reels that can be pivotally installed between the upper fixed seat and the lower fixed seat (6), and a rolling shutter component (7) located on the reel, the reel is internally provided with a torsion spring to apply elastic force to the reel so that the reel can rotate in a direction that makes the roller shutter component (7) retract.

2. The dual-shutter telescopic door railing according to claim 1, wherein the two reels are opposite in the rotation direction.

3. The dual-shutter telescopic door railing according to claim 1, wherein the bottom of the upper fixed seat is pivotally spaced with two connecting ends (11) for connection with the reel, and a locking mechanism is provided to lock the connecting end (11) with the upper fixed seat (1).

4. The dual-shutter telescopic door railing according to claim 3, wherein the connecting end (11) can be pivotally installed at the bottom of the upper fixed seat (1), the locking mechanism includes a first ratchet wheel (21) located inside the upper fixed seat (1) for fixed connection with the top of the connecting end (11), and a first pawl (22) can be pivotally provided inside the upper fixed seat (1) on the side corresponding to the first ratchet wheel (21), the first pawl (22) can swing between the position where it is engaged with the first ratchet wheel (21) and the position where it is far away from the first ratchet wheel (21), and a swinging member (23) can be pivotally installed on the side of the first pawl (22), far away from the first ratchet wheel (21), inside the upper fixed seat (1), and the swinging member (23) can swing between the position where it is partially engaged with the outer side of the first pawl (22) and the position where it is far away from the first pawl (22), and the locking mechanism also includes a first top spring (24) and an unlocking member, the first top spring (24) is used to apply elastic force to the direction in which swinging member (23) engages with the first pawl (22), the unlocking member is linked to the first pawl and the swinging member, and the unlocking member is partially exposed outside the upper fixed seat, the exposed part can be used to control the movement of unlocking member to force the swinging member (23) to swing away from the first pawl (22) and to force the first pawl (22) to swing away from the first ratchet wheel (21).

5. The dual-shutter telescopic door railing according to claim 1, wherein the upper fixed seat (1) is detachably fixed to the installation position through a quick release structure.

6. The dual-shutter telescopic door railing according to claim 1, further including a connecting mechanism for detachably connecting the shutter body of the rolling shutter component (7), after unfolding, to the free end of the shutter body.

7. The dual-shutter telescopic door railing according to claim 6, wherein the connecting mechanism includes a connecting rod (81), a pillar (82), an upper connecting seat (83), and a lower connecting seat (84), the upper connecting seat (83) and the lower connecting seat (84) are respectively connected to the two ends of the pillar (82), and the connecting rod (81) is connected to the free end of the shutter body, and the shutter body, after being pulled out, can be detachably connected to the upper connecting seat (83) and the lower connecting seat (84) through the two ends of the connecting rod (81) so that the free end of the shutter body and the connecting mechanism are detachably connected.

8. The dual-shutter telescopic door railing according to claim 7, wherein the bottom of the lower connecting seat (84) is provided with a first slot (841) for the insertion of the lower end of connecting rod (81), the upper connecting seat (83) is provided with a second slot (831), the upper end of the connecting rod (81) is movably provided with a locking member (811), and the locking member (811) can move relative to the connecting rod between the position where the locking member (811) extends into the second slot (831) to lock the connecting rod (81) and the position where the locking member (811) exits from the second slot (831) to unlock the connecting rod (81), and the connecting rod (81) is internally provided with a fourth top spring (85) that is used to apply elastic force to the locking element (811) in the direction in which the locking element (811) extends into the second slot (831).

9. The dual-shutter telescopic door railing according to claim 8, wherein a first moving member (832) and a second moving member (833) are vertically and movably installed inside the upper connecting seat (83), and the first moving member (832), during descending, can force the locking member (811) to exit the second slot (831), the second moving member (833) that partially extends out of the upper connecting seat (83) is exposed to the outside, the upper connecting seat (83) is also movably installed with a third moving member (834), and the bottom of the third moving member (834) is provided with a first inclined plane (835) and a second inclined plane (836) that are in opposite directions, the third moving member (834) can move between the position where the third moving member (834), through the first inclined plane (835), forces the first moving member (832) to perform a downward motion and the position where the third moving member (834), through the second inclined plane (835), forces the second moving member (833) to perform a downward motion, and a fifth top spring (837) is additionally provided to apply elastic force to the second moving member (833) in the direction in which the second moving member (833) moves away from the second inclined plane (836).

10. The dual-shutter telescopic door railing according to claim 7, wherein the pillar (82) is movably sleeved with a first slider (86) for fixed connection with the installation position.

11. The dual-shutter telescopic door railing according to claim 1, wherein the upper fixed seat and the lower fixed seat (6) are fixedly connected by a support rod (87), and the lower fixed seat (6) is provided with a vertical penetrating installation hole (61) that is used to, together with bolts, lock the lower fixed seat (6) on the ground.

12. The dual-shutter telescopic door railing according to claim 1, wherein the lower fixed seat (6) can be pivotally mounted with a second ratchet wheel (62) for connecting with the end of the torsion spring, and the second ratchet wheel (62) can rotate, relative to the lower fixed seat (6), in the direction of radial contraction of the torsion spring to adjust the torsion force of torsion spring.

13. The dual-shutter telescopic door railing according to claim 12, wherein a second pawl (63) can be pivotally installed at a position on one side of the lower fixed seat (6) corresponding to the second ratchet wheel (62), the second pawl (63) can move between the position where it engages with the second ratchet wheel (62) and the position where it disengages with the second ratchet wheel (62), and the ratchet wheel, when engaged, can only rotate in the direction that causes the torsion spring to contract radially, a sixth top spring (64) is additionally provided to apply elastic force to the second pawl (63) so that the second pawl (63) swings in the direction of engagement with the second ratchet wheel (62) and maintains contact with the second ratchet wheel (62).

14. The dual-shutter telescopic door railing according to claim 12, wherein the lower fixed seat (6) is open at the position corresponding to the center of the second ratchet wheel (62), and a strip groove (621) is provided at the center of the second ratchet wheel (62).

15. The dual-shutter telescopic door railing according to claim 11, wherein the support rod (87) is movably sleeved with a second slider (88) for fixed connection with the installation position.
